(19) United States
(12) Patent Application Publication
(10) Pub. No.: US 2004/0263312 A1
(43) Pub. Date: Dec. 30, 2004

(54) Switches

(76) Inventors: Brian Johnson, Cornwall (GB); Romain Henri Gabriel Anguila, Hampshire (GB)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/822,640

(22) Filed: Apr. 12, 2004

(30) Foreign Application Priority Data
Apr. 17, 2003 (GB) 0308982.8
Sep. 26, 2003 (EP) 03256084.9

(51) Int. Cl. H01C 10/14

(52) U.S. Cl. 338/12; 338/47

(57) ABSTRACT

The present invention provides an electromechanical switch arrangement, having at least one contact 7 that is movable relative to one or more other contacts 8, 9 within the switch, and further comprising a variably resistive material 20. The variably resistive material 20 being arranged such that as the contacts 7, 8, 9 move from an open condition to a closed condition, a force is applied to the variably resistive material 20 to provide a current flow path through the switch before the contacts 7, 8, 9 are in electrical contact.

The present invention relates to switches, in particular, although not exclusively, to switches wherein one or more electrical contacts moves relative to other electrical contacts.

Existing switches comprising movable electrical contacts suffer from arcing when they are opened and closed with potentials that exceed the arcing voltage of the material from which the electrical contacts of the switch are made. Such arcing causes degradation of the contacts.

This problem is even more severe when switching power into highly capacitative loads. In this case, when the contacts are closed a sudden rush of current creates a powerful arc, which erodes the contact and significantly reduces the number of operations of the switch.

As an alternative to electromechanical switches, solid state devices have been developed. Solid state switches have the advantage that the resistance of the switch reduces exponentially, therefore no sudden rush of current is exhibited. In addition, the energy is dissipated throughout the material of the switch and therefore no arcing is exhibited.

However, at the present time, these devices cannot achieve the low contact resistance that is usually a feature of electromechanical switches. Furthermore, a solid state switch cannot easily dissipate the heat energy produced within the switch. In addition, it is difficult to manufacture high current electrical contacts for solid state devices.

Quantum tunnelling composite materials (QTC), or variably resistive materials, are generally known. Such materials change from being an electrical insulator to being an electrical conductor upon application of force to the material, for example by compression, twisting, or the like, and vice versa. The resistance of a QTC material will gradually reduce upon application of a force, and gradually increase on removal of the force.

International patent application number WO 01/88935 A1 discloses a flexible switching device comprising a QTC material. In this case, the switch comprises a sheet of QTC material sandwiched between two layers of textile material, which textile material layers provide electrodes and are connected to external circuitry. Due to the abutting relation of the layers, application of pressure to the textile-form electrodes effects application of pressure to the QTC material, which causes the resistance of the QTC material to decrease and allow current to flow between the electrodes. Removal of pressure from the textile material effects a removal of pressure from the QTC material and the resistance of the QTC material increases to eventually prevent the flow of current between the electrodes.

It is an object of preferred embodiments of the present invention to provide an improved switch wherein one or more electrical contacts of the switch move relative to other electrical contacts.

A first aspect of the present invention provides a switch having a first electrical contact and a second electrical contact, at least one of the first and second contact being movable relative to the other contact, such that the contacts can be moved between an open condition, wherein the contacts are spaced apart, and a closed condition, wherein the contacts are in contact, and a variably resistive material arranged such that, as the contacts move from the open condition to the closed condition, a force is applied to the variably resistant material to provide a current flow path through the switch before the contacts are in electrical contact.

The variably resistive material may be any material that exhibits a reduction of electrical resistance upon application of a force thereto. An example of a suitable material is described in International patent application number PCT/GB99/00205, the disclosure of which is incorporated herein by reference.

The variably resistive material may have any suitable form, including the form of a coating on part at least of a contact. Preferably, the variably resistive material is in the form of a body of material.

Variably resistive material may be attached, either directly or indirectly, to one or both of the first and second electrical contacts. Alternatively, or in addition, variably resistive material may be separate from one or both of the electrical contacts. The variably resistive material is suitably located between contacting faces of the first and second contacts. The variably resistive material should be arranged such that when the force is applied thereto by movement of one or more of the contacts, the variably resistive material forms a bridge between the first and second contacts in order to facilitate provision of the current flow path through the switch.

The force applied to the variably resistive material may be any suitable force that effects a reduction in resistance of the material as the force is applied, and may depend upon the specific composition and conformation of the material. For example, a compression force, a stretching force or a twisting force may be applied to the variably resistive material.

When the contacts are in the open position, there is preferably substantially no force being applied to the variably resistive material. In the open condition the variably resistive material may be in contact with both the first and second electrical contacts. When the contacts are in the open condition, the variably resistive material may be spaced from one at least of the first and second contacts. Preferably, in the open condition the variably resistive material is in contact with both electrical contacts, but without application of a force significant enough to reduce the resistance of the variably resistive material enough to allow a current to pass between the electrodes.

Both of the first and second contacts may be movable relative to the other.

The switch may comprise more than two contacts. For example, a switch with three contacts may be arranged with one contact movable from an open condition, wherein it contacts neither of the other two contacts, to a closed position, wherein it contacts either one of the other two contacts. Alternatively, a switch comprising a third contact may be arranged such that one of the contacts forms a bridge between the other two contacts when the contacts are in the closed position. In this case, either the bridging contact, the other two contacts or all three contacts may be movable.

If the switch comprises more than two contacts, variably resistive material may be arranged relative to one only of the points of contact of the contacts, but is suitably arranged relative to more than one of the points of contact. Preferably, variably resistive material is arranged relative to each point of contact in the switch.

The present invention may be applied to any suitable switch, and in particular, a switch wherein gradual switching is preferrable; including electromechanical switches such as trip switches, battery cut-off devices, light switches, electrical socket switches, electrical drills and the like.

A switch according to the present invention may be arranged for use with any voltage. For example, a switch according to the present invention may be used with any voltage up to and including 500V.

The contacts may have any suitably form, and many different types of conventional contact are known. Alternatively, or in addition, one or more of the contacts may comprise a contact as described below in accordance with the second aspect of the invention.

In use of a switch in accordance with the first aspect of the present invention, when the switch is activated, the one or more movable contacts move towards each other to pass from the open condition to the closed condition. As the one or more contacts move the variably resistive material provides a bridge between the contacts, and a force is gradually applied to the variably resistive material. Application of the force causes the resistance of the material to reduce exponentially, thereby providing for a gradually increasing current flow through the switch as the resistance decreases. Once the contacts are in contact with one another, full current flow through the switch is achieved. When the switch is closed, the contacts move apart and the force applied to the variably resistive material gradually decreases. This causes the resistance of the variably resistive material to increase exponentially, effecting a gradual reduction of the current flow through the switch.

The first aspect of the present invention advantageously provides a switch arrangement wherein the current flow through the switch gradually increases as the contacts move from the open condition to the closed condition, and the current flow through the switch is gradually reduced as the contacts move from the closed condition to the open condition. Therefore, the occurrence of arcing within the switch is substantially, in not completely, eliminated.

A second aspect of the present invention provides a pair of electrical contacts comprising a first fixed contact having at least one electrical contact surface and a second contact, the second contact being moveable relative to the first contact to move the contacts between a closed position, wherein electrical contact surfaces of the first and second contacts are in contact and an open position, wherein electrical contact surfaces of the first and second contacts are spaced apart, the second contact having a convexly curved electrical contact surface, and said second contact being adapted to rotate about a pivot axis transverse of the electrical contact surface of the first contact.

The electrical contact surface of the first contact may be substantially planar or convexly curved.

A pair of electrical contacts according to the second aspect of the present invention may provide the only switching point of an electrical switch. Alternatively, a pair of electrical contacts according to the second aspect of the present invention may provide one or more switching points of a multi-point switch.

The electrical contact surface of one or both of the first and second electrical contacts of the second aspect may be provided by a surface of the electrical contact.

Alternatively, the electrical contact surface of one or both of the first and second electrical contacts of the second aspect may be provided by a separate element mounted on a contact body. The contact body may comprise one or more electrical contact surfaces. Each electrical contact surface may be directly or indirectly mounted on the contact body. Each electrical contact surface may be fixedly secured relative to the contact body or moveably secured relative to the contact body.

The pivotal motion of the movable contact may be achieved by any suitable method. For example, the movable contact may be spring mounted.

Suitably, the movable contact is carried on an armature, and the contact is held in position on the armature by means of a spring. The armature is suitably arranged on an incline relative to the first and second contacts, such that the action of the spring against the movable contact forces the movable contact into an inclined orientation corresponding to the inclined orientation of the armature. Therefore, when in the open position, the movable contact is inclined relative to the fixed contact.

As the movable contact moves into the closed position, the armature carrying the movable contact moves towards the fixed contact, and the action of the spring maintains the movable contact in the inclined orientation. As the movable contact makes contact with the fixed contact, the armature carries on moving for a distance at least sufficient to separate the movable contact from the armature. The action of the spring now forces the movable contact back into a non-inclined orientation, wherein the movable contact becomes substantially parallel to the fixed contact. Thus effecting a rocking motion of the movable contact relative to the fixed contact. In the closed position, the movable contact stabilises in a substantially non-inclined orientation, wherein it is substantially parallel to the fixed contact, by virtue of the pressure exerted on the movable contact by the spring.

In use of a pair of electrical contacts according to the second aspect of the invention, starting from an open position, the second contact moves towards the first contact to bring the electrical contact surfaces of the first and second contacts into contact and thereby place the contacts in the closed position. When the electrical contact surfaces of the first and second contacts meet, the second contacts rotates about the pivot axis causing the curved electrical contact surface of the second contact to roll back and forth over the contact surface of the first electrical contact.

The rocking motion of the electrical contact surface of the second contact over the surface of the electrical contact surface of the first contact cleans the contact surfaces due to the friction therebetween, thereby helping to maintain the conductivity of the contacts.

Any feature of the first aspect of the invention may be combined with any feature of the second aspect of the invention.

The present invention will now be described, by way of example only, with reference to the following drawings, in which:—

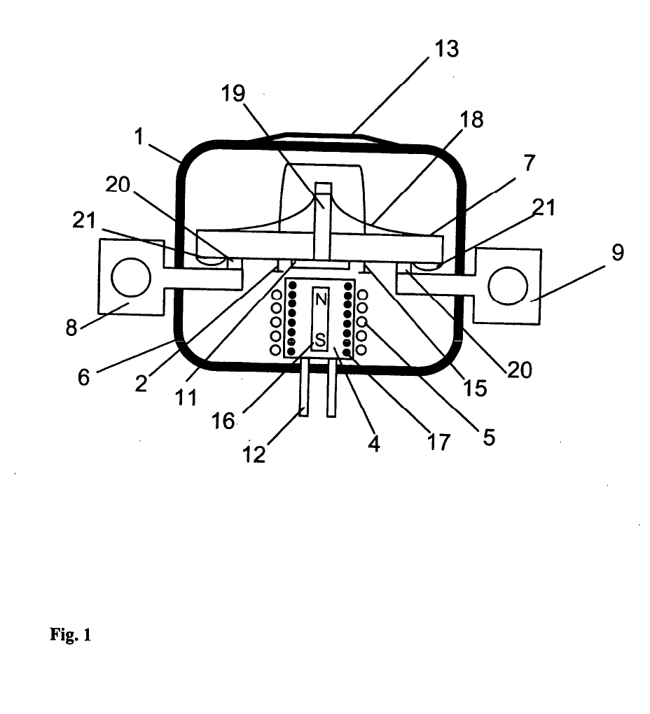

FIG. 1 illustrates a schematic sectional view of a battery cut-off device in accordance with the first and second aspects of the present invention, and

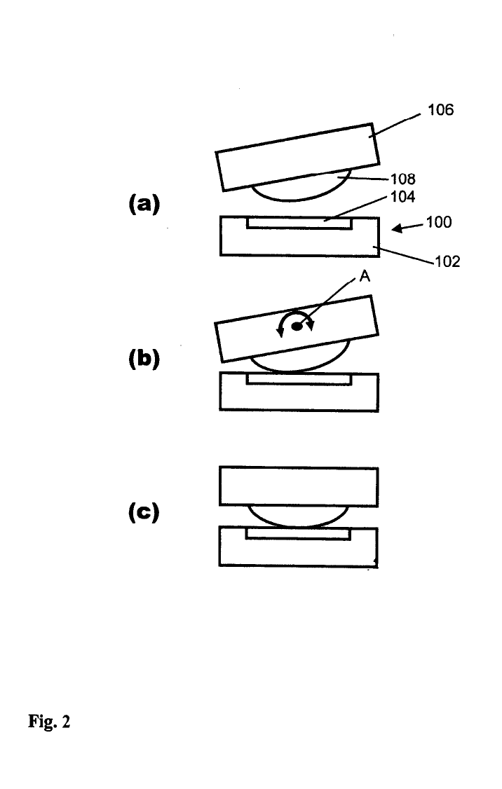

FIG. 2 illustrates the action of a pair of electrical contacts according to the second aspect of the present invention, and as illustrated in FIG. 1.

The switch of FIG. 1 comprises a main body 6, comprising a base portion and sidewalls terminating in an upper rim surface. First and second fixed contacts 8 and 9 extend though oppositely disposed ones of the sides walls, each fixed contact having an exterior lug, shown with a circular aperture, and an interior upwardly facing contact surface.

A cover or cap 1 abuts the upper rim surface of the main body 6. Arranged on the upper surface of cover 1 is a flexible membrane 13 forming a reset button.

A solenoid 4 is received in the base portion of the main body 6 and performs a latching function as described further below. The latching solenoid 4 has arranged therein a magnet, in the form of permanent magnet 16, and a solenoid coil 17. A printed circuit board (PCB) (not shown) is also included in the device, which PCB has a microswitch (not shown) and a pair of external trigger contacts 12. In use, the external trigger contacts 12 may be electrically connected to any external system that may demand that the battery is disconnected, for example, a short-circuit detection system. The switch may be used in a system with any voltage. For example, the switch may be used in a system with a voltage, up to and including 500V.

The PCB is arranged such that the solenoid coil 17 is connected to power and earth as appropriate.

A carrier assembly is arranged in the interior of the battery cut off device. The carrier assembly 2 has a hollow interior, which is sufficiently large to allow an upper portion of the latching solenoid 4 freely to move up and down therein. Sidewalls of the carrier assembly terminate in a lower rim surface 15.

The carrier assembly 2 has a bridge contact 7 extending laterally therethrough. First and second ends of the bridge contact 7 are provided with convexly curved contact surfaces 21, which are arranged physically and electrically to contact the interior upwardly facing contact surface of the fixed contacts 8 and 9, when the device is in the closed position.

The carrier assembly 2 further comprises a keeper plate or armature 11 arranged above the latching solenoid 4 and suspended by a strut 19 that extends through an aperture in the bridge contact 7 from a blade spring 18 arranged upstanding from the upper surface of the bridge contact 7. The function of the keeper plate is to provide a magnetisable element of the carrier assembly 2, which interacts with the magnetic fields, permanent and transient, generated by the latching solenoid 4. The blade spring 18 and strut 19 are arranged so that the keeper plate 11 is suspended a small distance above the solenoid 4 when the blade spring 18 is biased and the bridge contact 7 is in contact with the fixed contacts 8 and 9, in the closed position. The small distance is such that the keeper plate 11 experiences an attractive force from the permanent magnet 16 sufficient to cause the keeper plate 11 to be pulled down against the bias of the blade spring 18. This assists in a positive contact between the bridge 7 and fixed contacts 8, 9.

The keeper plate 11 has an inclined orientation relative to the fixed electrodes 8, 9, which is not shown in FIG. 1. The keeper plate is inclined such that the front edge as viewed in FIG. 1 is either lower or higher than the back edge. The orientation of the bridge contact 7 of FIG. 1, when viewed from the direction of arrow x, would be as illustrated by contact 106 in FIG. 2, when the bridge contact 7 is in contact with the keeper plate 11. When the contacts 7, 8, 9 are in the open position (as shown in FIG. 1) the action of the spring 18 on the bridge contact 7 pushes the bridge contact 7 onto the inclined keeper plate 11, causing the bridge contact 7 to be inclined in the same manner as the keeper plate 11.

As the keeper plate is pushed down towards the solenoid, to place the contacts, 7, 8, 9 in the closed position, the bridge contact 7 contacts the fixed electrodes 8, 9 before the keeper plate 11 stops moving. The bridge contact is therefor no longer in contact with the inclined keeper plate 11. The action of the spring 18 on the bridge contact 7 causes the bridge contact to rotate about the pivot axis A, as indicated in FIG. 2 and the convexly curved contact surfaces 21 of the bridge contact 7 rock back and forth over the contact surfaces of the fixed electrodes 8, 9. The bridge contact 7 will eventually stabilise in an orientation that is substantially parallel with the fixed electrodes, due to the even load of the spring 18 on the upper surface of the bridge contact 7.

A separate keeper plate 11 is shown in the drawing, but it will be understood that a central portion of the bridge contact 7 could perform this function. In which case, a separate keeper plate and also the blade spring could be dispensed with.

A spring 5, in the form of a helical compression spring is arranged concentrically around the latching solenoid 4. One end of the compression spring 5 presses against the base portion of the main body 6 and the other end presses against the lower rim surface 15 of the carrier assembly 2. The compression spring 5 thus acts to urge the carrier assembly 2 upward within the interior volume of the device, away from the base portion of the main body 6.

In addition, a body of variably resistive material 20 is attached to the bridge contact 7 at each end thereof, adjacent the contact surfaces 21 thereof. Each body of variably resistive material 20 extends from the surface of the bridge contact 7 towards the interior upwardly facing contact surface of each of the fixed contacts 8, 9. In the open position, illustrated in FIG. 1, each body of variably resistive material 20 is arranged to just touch the interior upwardly facing contact surface of each respective fixed contact 8, 9 without application of significant pressure to the body of variably resistive material 20. Each body of variably resistive material 20 is of a size such that the contact surfaces 21 of the bridge contact 7 can physical make contact with the contact faces of the fixed contacts 8, 9 when the contacts are in the closed position.

In its normally closed condition, the bridge contact 7, is held against the fixed contacts 8, 9, allowing current to flow from the first fixed contact 8 to the second fixed contact 9. In this condition, each body of variably resistive material 20 is compressed. This closed condition is maintained by action of the permanent magnet 16 attracting the keeper plate 11, because the magnetic attraction force between the permanent magnet 16 and the keeper plate 11 exceeds the upwardly acting force of the compressed spring 5.

The device is tripped from the normal closed configuration, into an open condition, by application of an electrical impulse through the printed circuit board. The impulse will generally be triggered by an external source energising the external trigger contacts 12. However, the device may also comprise a manual trip switch so that manual actuation of the microswitch in the PCB can move the device into the open condition.

The electrical impulse passes to the coil 17 of the solenoid 4 and generates a magnetic field, which counteracts that of the permanent magnet 16. The urging force of the compression spring 5 then exceeds the combined net magnetic force of the permanent magnet and the transient magnetic field, and the carrier assembly 2 is pushed upwards away from the latching solenoid into an open condition, in which the bridge contact 7 is separated from the fixed contacts 8 and 9 and supported by the keeper plate 11.

As the bridge contact 7 moves away from the fixed contacts 8, 9, the compression force on the variably resistive material 20 reduces, and thus the resistance of the material increases. Therefore, the current flowing through the switch will gradually decrease as the contacts open, until the variably resistive material 20 is separated from the fixed contacts 8, 9 and no current can flow through the switch.

The battery cut-off device can be manually reset by depressing the reset button 13, which pushes the carrier assembly 2 downwards until the keeper plate is sufficiently attracted by the permanent magnet 16 to overcome the urging force of the compression spring 5, and the contacts 21, 8, 9 are held in the closed condition.

As the device is re-set, the bridge contact 7 is moved towards the fixed contacts 8, 9 and each body of variably resistive material 20 contacts the contact surfaces of the fixed contacts 8, 9, forming an electrical connection between the bridge 7 and fixed 8, 9 contacts. As the bridge contact 7 continues to move towards the fixed contacts 8, 9, the variably resistive material 20 is gradually compressed. As the variably resistive material 20 is compressed the resistance thereof gradually decreases, and the amount of current that can flow through the switch gradually increases. When the switch is fully closed, the contact surfaces 21 of the bridge contact 7 are in contact with the interior upwardly facing contact surfaces of each of the fixed contacts 8, 9 and current can flow from the first fixed contact 8 to the second fixed contact 9 at full flow rate.

FIG. 2 shows a first, fixed contact 100, comprising a body 102 and an electrical contact surface 104. A second, moveable contact 106 is inclined relative to the fixed contact 100 and is movable towards and away from the first contact 100 as appropriate. The second contact 106 comprises an electrical contact surface 108 that is convexly curved.

FIG. 2(a) shows the contacts 100, 106 in the open position. In FIG. 2(b) the curved surface of the second electrical contact surface 108 has made contact with the planar surface of the first electrical contact surface 104 and the contacts are closed. The rotative motion of the second contact about pivot axis A causes the second contact surface 108 to roll over the first contact surface 104. The friction between the two surfaces effects cleaning of the contacts surfaces 104, 108. FIG. 2(c) shows contacts 100, 106 in a stable closed position.

1. (original) a switch having a first electrical contact and a second electrical contact, at least one of the first and second contacts being movable relative to the other contact, such that the contacts can be moved between an open condition, wherein the contacts are spaced apart, and a closed condition, wherein the contacts are in contact, and a variably resistive material arranged such that as the contacts move from the open condition to the closed condition, a force is applied to the variably resistant material to provide a current flow path through the switch before the contacts are in electrical contact.

2. A switch according to claim 1, wherein the variably resistive material exhibits a reduction of resistance upon application of force thereto.

3. A switch according to claim 1, comprising a third contact.

4. A switch according to claim 3, wherein the one of the contacts is arranged to form a bridge between the other two contacts, when the contacts are in the closed position.

5. A switch according to claim 1, wherein a body of variably resistive material is attached to one at least of the contacts.

6. A switch according to claim 5, wherein when the switch is in the open position, the body of variably resistive material is in contact with one only of the contacts.

7. A switch according to claim 1, wherein the variably resistive material is arranged such that as the contacts move from the open condition to the closed condition, the variably resistive material provides a current flow path between the contacts before the contacts make contact with one another.

8. A switch according to claim 1, wherein the variably resistive material is arranged such that it is compressed as the contacts move from the open condition to the closed condition.

9. A switch according to claim 1, wherein variably resistive material is arranged relative to each contact point within the switch.

10. A switch according to claim 1, wherein the first electrical contact is a fixed contact having at least one electrical contact, the second contact being moveable relative to the first contact to move the contacts between the closed condition and the open condition, the second contact having a convexly curved electrical contact surface, and the second contact being adapted to rotate about a pivot axis tranverse of the electrical contact surface of the first contact.

11. A switch according to claim 10, wherein the electrical contact surface of the first contact is substantially planar.

12. A switch according to claim 11, wherein the electrical contact surface of the first contact is convexly curved.

13. A switch according to claim 10, wherein the movable contact is inclined relative to the fixed contact when the contacts are in the open condition, but on contact with the fixed contact is caused to rotate into an orientation substantially parallel to the fixed contact by virtue of a force applied to the movable contact.

14. A switch according to claim 13, wherein the force applied to the movable contact to cause it to rotate is generated by a spring acting upon the movable contact.
